(19) United States
(12) Patent Application Publication
(10) Pub. No.: US 2015/0333366 A1
(43) Pub. Date: Nov. 19, 2015

(54) LITHIUM ION SECONDARY BATTERY

(71) Applicant: TDK CORPORATION, Tokyo (JP)

(72) Inventors: Hiroshi SATO, Tokyo (JP); Tetsuya UENO, Tokyo (JP); Ayaka HORIKAWA, Tokyo (JP); Keitaro OTSUKI, Tokyo (JP)

(21) Appl. No.: 14/707,722

(22) Filed: May 8, 2015

(30) Foreign Application Priority Data
May 19, 2014 (JP) 2014-103035
Apr. 15, 2015 (JP) 2015-083425

(51) Int. Cl. H01M 10/0525; H01M 4/66; H01M 4/38; H01M 4/58; H01M 10/0562; H01M 4/36

(52) U.S. Cl. CPC H01M 10/0525; H01M 10/0562; H01M 4/362; H01M 4/38; H01M 4/5825; H01M 4/661; H01M 2220/30; H01M 2300/0068

(57) ABSTRACT

A provided lithium ion secondary battery includes a pair of electrodes and a solid electrolyte layer. The solid electrolyte layer is provided between the pair of electrodes and includes titanium aluminum lithium phosphate. At least one of the pair of electrodes includes vanadium lithium phosphate. At least one of the pair of electrodes includes at least one constituent of titanium and aluminum. The amount of the at least one constituent existing on a side opposite to the solid electrolyte layer is smaller than the amount of the at least one constituent existing on the solid electrolyte layer side.

### CROSS-REFERENCE TO RELATED APPLICATION

This application claims priority from Japanese Patent Application No. 2014-103035 filed with the Japan Patent Office on May 19, 2014, and Japanese Patent Application No. 2015-083425 filed with the Japan Patent Office on Apr. 15, 2015, the entire contents of which are hereby incorporated by reference.

### BACKGROUND

1. Technical Field

The present disclosure relates to a lithium ion secondary battery.

2. Related Art

Electronics techniques have made remarkable advances in recent years. Portable electronic appliances have achieved reduction in size, weight, and thickness and increase in functionality. Along with this, the battery used as a power source of the electronic appliance has been strongly desired to have smaller size, weight, and thickness and higher reliability. In view of this, an all-solid lithium ion secondary battery including a solid electrolyte has attracted attention.

In general, all-solid lithium ion secondary batteries are classified into two types of a thin-film type and a bulk type. The thin-film type is manufactured by a thin-film technique such as a PVD method or a sol-gel method. The bulk type is manufactured by powder compacting of an active material or a sulfide-based solid electrolyte with low grain-boundary resistance. As for the thin-film type, it is difficult to increase the thickness of the active material layer and to increase the number of layers. This results in problems that the capacity is low and the manufacturing cost is high. On the other hand, the bulk type employs the sulfide-based solid electrolyte. The sulfide-based solid electrolyte reacts with water to generate hydrogen sulfide. In view of this, it is necessary to manufacture the battery in a glove box with a managed dew point. Moreover, it is difficult to make the solid electrolyte layer into sheet. Thus, decreasing the thickness of the solid electrolyte layer and increasing the number of layers of the battery have been an issue.

In view of the above circumstances, Japanese Domestic Re-publication of PCT International Publication No. 07-135790 describes the all-solid battery manufactured by the industrially applicable manufacturing method that enables the mass production. This all-solid battery is manufactured by stacking members made into sheets using the oxide-based solid electrolyte, which is stable in the air, and firing the members at the same time. However, since the different kinds of materials are fired at the same time, it has been difficult to firmly bond the solid electrolyte layer and the positive and negative electrode layers.

In view of this, Japanese Patent No. 04797105 has disclosed the multilayer all-solid lithium ion secondary battery including the stacked body in which the positive electrode layer including the positive electrode active material and the negative electrode layer including the negative electrode active material are stacked with the electrolyte layer including the solid electrolyte interposed therebetween. This multilayer all-solid lithium ion secondary battery has the intermediate layer including the material functioning as the active material or the electrolyte at the interface between the electrolyte layer, and the positive electrode layer and/or the negative electrode layer. The intermediate layer is formed by having the positive electrode active material and/or the negative electrode active material, and the solid electrolyte subjected to the reaction and/or diffusion. If the intermediate layer is formed on the solid electrolyte side, however, the short-circuiting is likely to occur; in this case, the reliability is low.

### SUMMARY

The lithium ion secondary battery according to the present disclosure includes a pair of electrodes and a solid electrolyte layer. The solid electrolyte layer is provided between the pair of electrodes and includes titanium aluminum lithium phosphate. At least one of the pair of electrodes includes vanadium lithium phosphate. At least one of the pair of electrodes includes at least one constituent of titanium and aluminum. The amount of the at least one constituent existing on a side opposite to the solid electrolyte layer is smaller than the amount of the at least one constituent existing on the solid electrolyte layer side.

### BRIEF DESCRIPTION OF THE DRAWINGS

FIG. 1 is a sectional view illustrating a conceptual structure of a stacked body portion of a lithium ion secondary battery.

FIG. 2 illustrates the EPMA-WDS element mapping of the section of the stacked body of Example 1-2.

FIG. 3 illustrates the secondary electron image of the stacked body section of Example 1-2.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide a lithium ion secondary battery with low internal resistance and high reliability for solving the above conventional problem.

To solve the above described problem, a lithium ion secondary battery according to the present disclosure includes a pair of electrodes and a solid electrolyte layer. The solid electrolyte layer is provided between the pair of electrodes and includes titanium aluminum lithium phosphate. At least one of the pair of electrodes includes vanadium lithium phosphate. At least one of the pair of electrodes includes at least one constituent of titanium and aluminum. The amount of the at least one constituent existing on a side opposite to the solid electrolyte layer is smaller than the amount of the at least one constituent existing on the solid electrolyte layer side in the at least one electrode.

In the lithium ion secondary battery with the above structure, titanium and/or aluminum is optimally disposed in the positive electrode active material layer and/or the negative electrode active material layer. These constituents are distributed with gradation. In other words, the amount of the constituent existing far from the solid electrolyte layer is smaller than that of the constituent existing close to the solid electrolyte layer. Thus, the lithium ion secondary battery with not just the internal resistance reduced but also the reliability improved can be provided.

A lithium ion secondary battery according to the present disclosure includes a positive electrode layer, a negative electrode layer, and a solid electrolyte layer. The positive electrode layer includes a positive electrode current collector layer and a positive electrode active material layer. The negative electrode layer includes a negative electrode current collector layer and a negative electrode active material layer. The solid electrolyte layer is provided between the positive electrode active material layer and the negative electrode active material layer, and includes titanium aluminum lithium phosphate. At least one layer of the positive electrode active material layer and the negative electrode active material layer includes vanadium lithium phosphate and includes at least one constituent of titanium and aluminum. The amount of the at least one constituent existing on the current collector layer side is smaller than the amount of the at least one constituent existing on the solid electrolyte layer side in the at least one layer.

According to the lithium ion secondary battery with the above structure, titanium and/or aluminum is disposed optimally in the positive electrode active material layer and/or the negative electrode active material layer. The constituents are distributed with gradation. In other words, the amount of the constituent existing on the positive electrode current collector layer side and/or the negative electrode current collector layer side is smaller than that of the constituent existing on the solid electrolyte layer side. Thus, the lithium ion secondary battery with not just the internal resistance reduced but also the reliability improved can be provided.

In the lithium ion secondary battery according to the present disclosure, titanium aluminum lithium phosphate may be Li₁+ₓAlₓTi₂₋ₓ(PO₄)₃ (0≦x≦0.6).

According to the lithium ion secondary battery with the above structure, the short-circuiting of the battery may be suppressed and the reliability thereof is improved.

In the lithium ion secondary battery according to the present disclosure, vanadium lithium phosphate is at least one of LiVOPO₄ and Li₃V₂(PO₄)₃.

According to the lithium ion secondary battery with the above structure, the short-circuiting of the battery is suppressed and the reliability thereof is improved.

In the lithium ion secondary battery according to the present disclosure, the positive electrode current collector layer and the negative electrode current collector layer may include Cu.

In the lithium ion secondary battery according to the present disclosure, the materials included in the positive electrode current collector layer and the negative electrode current collector layer do not react with titanium aluminum lithium phosphate. Therefore, the effect of further reducing the internal resistance of the lithium ion secondary battery is obtained.

A lithium ion secondary battery according to the present disclosure includes a positive electrode layer, a negative electrode layer, and a solid electrolyte layer. The positive electrode layer includes a positive electrode current collector layer and a positive electrode active material layer. The negative electrode layer includes a negative electrode current collector layer and a negative electrode active material layer. The solid electrolyte layer is provided between the positive electrode active material layer and the negative electrode active material layer, and includes titanium aluminum lithium phosphate. At least one layer of the positive electrode active material layer and the negative electrode active material layer includes vanadium lithium phosphate and includes at least one constituent of titanium and aluminum. The at least one constituent of titanium and aluminum is diffused in the vanadium lithium phosphate.

In the lithium ion secondary battery according to the present disclosure, at least one constituent of titanium and aluminum is diffused in vanadium lithium phosphate. Therefore, the bond is firm at the interface between the positive electrode active material layer and/or the negative electrode active material layer including vanadium lithium phosphate, and the solid electrolyte layer bonded to these layers. At the same time, the interface resistance is reduced, thereby reducing the internal resistance of the lithium ion secondary battery. Moreover, vanadium lithium phosphate is not diffused into the solid electrolyte layer. Therefore, the short-circuiting of the lithium ion secondary battery is suppressed to allow the battery to have higher reliability.

According to the present disclosure, the lithium ion secondary battery with the low internal resistance and the high reliability can be provided.

An embodiment of the present disclosure is hereinafter described with reference to the drawings. Note that the lithium ion secondary battery of the present disclosure is not limited to the embodiment below. The component described below includes another component that is easily conceived by a person skilled in the art and the component that is substantially the same as the described component. The components in the description below can be used in combination as appropriate.

### (Structure of Lithium Ion Secondary Battery)

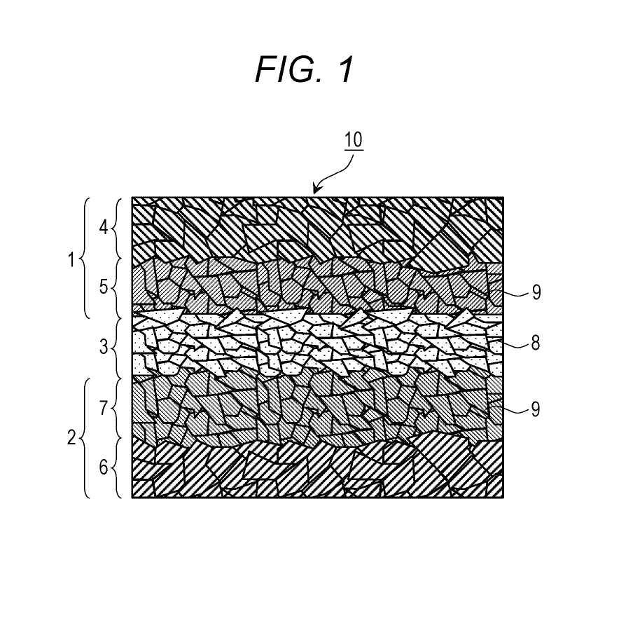

FIG. 1 is a sectional view illustrating a conceptual structure of a lithium ion secondary battery 10 according to an example of this embodiment. The lithium ion secondary battery 10 according to this embodiment is formed by stacking a positive electrode layer 1 and a negative electrode layer 2 as a pair of electrodes with a solid electrolyte layer 3 interposed therebetween. The positive electrode layer 1 includes a positive electrode current collector layer 4 and a positive electrode active material layer 5. The negative electrode layer 2 includes a negative electrode current collector layer 6 and a negative electrode active material layer 7.

The solid electrolyte layer 3 includes titanium aluminum lithium phosphate 8. At least one layer of the positive electrode active material layer 5 and the negative electrode active material layer 7 includes vanadium lithium phosphate 9. Note that in FIG. 1, both the positive electrode active material layer 5 and the negative electrode active material layer 7 include the vanadium lithium phosphate 9. Alternatively, just one of the both layers may include the vanadium lithium phosphate 9. In FIG. 1, the same materials with the same reference symbols are used. Needless to say, however, the embodiment of the present disclosure is not limited to this example and other materials may be used. In the description below, “active material” may refer to either or both of the positive electrode active material and the negative electrode active material. Further, “active material layers 5, 7” may refer to either or both of the positive electrode active material layer 5 and the negative electrode active material layer 7. In addition, “electrode” may refer to either or both of the positive electrode and the negative electrode.

Before sintering, at least one constituent of titanium and aluminum included in the titanium aluminum lithium phosphate 8 is not diffused in the vanadium lithium phosphate 9. Therefore, the bonding strength between the active material layers 5, 7 and also the solid electrolyte layer 3 is weak and the contact area therebetween is small. On the other hand, after sintering, at least one constituent of titanium and aluminum included in the titanium aluminum lithium phosphate 8 is diffused in the vanadium lithium phosphate 9 included in the active material layers 5, 7. Therefore, the firm bond is formed between the active material layers 5, 7 and the solid electrolyte layer 3. Moreover, the contact area at the interface between the active material layers 5, 7 and the solid electrolyte layer 3 is increased. For these reasons, the internal resistance of the lithium ion secondary battery 10 is reduced. Moreover, the vanadium constituent in the vanadium lithium phosphate 9 is not diffused in the titanium aluminum lithium phosphate 8. Therefore, the short-circuiting of the lithium ion secondary battery 10 is suppressed and the reliability thereof is improved.

According to this embodiment, vanadium in the vanadium lithium phosphate 9 is not diffused in the titanium aluminum lithium phosphate 8. Therefore, when the diffusion of at least one constituent of titanium and aluminum in the titanium aluminum lithium phosphate 8 into the vanadium lithium phosphate 9 is positively carried out, the firm bond is formed between the active material layers 5, 7 and the solid electrolyte layer 3.

It can be determined by the concentration gradient of the titanium and aluminum obtained by the element mapping on the section of the lithium ion secondary battery 10 with the use of the energy dispersive X-ray spectroscopy apparatus EDS or the wavelength dispersive X-ray spectroscopy apparatus WDS whether titanium and aluminum existing in at least one layer of the positive electrode active material layer 5 and the negative electrode active material layer 7 is the titanium and aluminum diffused out of the solid electrolyte layer 3. In other words, as described in this embodiment, it can be confirmed that the titanium and/or aluminum, which is neither the constituent element of the positive electrode active material nor the constituent element of the negative electrode active material, exist in the active material layers 5, 7 and that the titanium and/or aluminum distributed in the active material layers 5, 7 have the concentration gradient.

As described above, this embodiment has described the reduction of the internal resistance due to the diffusion of titanium and/or aluminum. In addition, it is important that the solid electrolyte layer 3 and the active material layers 5, 7 employ the same phosphate based material and that the active material layers employ the material including the element whose valence is largely variable. In other words, the materials sharing the backbone structure in the crystal lattice of the phosphate are bonded. Moreover, the valence of the vanadium included in the vanadium lithium phosphate 9 may be variable and may be trivalent, tetravalent, or pentavalent. By the use of such materials, the mobility of titanium and/or aluminum is improved. Thus, the titanium and/or aluminum is disposed at the optimum position in the active material layer. It is considered that this leads to the provision of the lithium ion secondary battery 10 having achieved not just the lower internal resistance but also the reliability which is higher than before in the acceleration test.

Thus, the characteristic structure of this embodiment is the gradient distribution of at least one constituent of titanium and aluminum in the active material layers 5, 7. The element concentration of the constituent is preferably lower on the side far from the solid electrolyte layer 3 (i.e., the side close to the positive electrode current collector layer 4 and/or the negative electrode current collector layer 6) than on the side close to the solid electrolyte layer 3. In general, at least one constituent is not diffused to the vicinity of the interface between the active material layer and the current collector layer. Therefore, if the acceleration test is conducted, the characteristics are not maintained in some cases. In this embodiment, however, at least one constituent of titanium and aluminum is diffused to the vicinity of the interface between the positive electrode active material layer 5 and the positive electrode current collector layer 4 or the vicinity of the interface between the negative electrode active material layer 7 and the negative electrode current collector layer 6, i.e., across the entire region of the active material layers 5, 7. This leads to the provision of the lithium ion secondary battery 10 that has achieved not just the lower internal resistance but also the reliability which is higher than before in the acceleration test.

In this embodiment, titanium and/or aluminum is diffused more homogenously across the entire region of the active material layers 5, 7. Therefore, the thickness of each of the positive electrode active material layer 5 and the negative electrode active material layer 7 may be 10 μm or less or 5 μm or less.

In this embodiment, at least one constituent of titanium and aluminum may be distributed to cover the particle surface of the active material in the active material layer.

The at least one constituent may exist even inside of the particle of the active material. Further, the constituent may be distributed with the concentration gradient from the surface of the particle to the inside of the particle.

The constituent materials included in the material of the solid electrolyte layer 3, the positive electrode active material layer 5 and the negative electrode active material layer 7 in the lithium ion secondary battery 10 of this embodiment can be identified by the X-ray diffraction measurement. The distribution of the titanium and aluminum can be analyzed by the EPMA-WDS element mapping.

FIG. 1 is a sectional view of the lithium ion secondary battery 10 including a pair of positive electrode layer 1 and negative electrode layer 2. The lithium ion secondary battery 10 of this embodiment, however, is not limited to the structure of FIG. 1 but may be formed by stacking arbitrary number of layers. The structure can be changed widely in accordance with the required capacity or current specification of the lithium ion secondary battery 10.

### (Solid Electrolyte)

The solid electrolyte layer 3 of the lithium ion secondary battery 10 of this embodiment includes the titanium aluminum lithium phosphate 8. As the titanium aluminum lithium phosphate 8, Li₁₊ₓAlₓTi₂₋ₓ(PO₄)₃ (0≦x≦0.6) can be used. The solid electrolyte layer 3 may alternatively include other solid electrolyte materials than the titanium aluminum lithium phosphate 8. For example, at least one selected from the group having Li₃₊ₓ₁Siₓ₁P₁₋ₓ₁O₄ (0.4≦x1≦0.6), Li_{3.4}V_{0.4}Ge_{0.6}O₄, germanium lithium phosphate (LiGe₂(PO₄)₃), Li₂O—V₂O₅—SiO₂, Li₂O—P₂O₅—B₂O₃, Li₃PO₄, Li_{0.5}La_{0.5}TiO₃, Li₁₄Zn(GeO₄)₄, and Li₇La₃Zr₂O₁₂ may be included.

### (Positive Electrode Active Material and Negative Electrode Active Material)

As described above, at least one layer of the positive electrode active material layer 5 and the negative electrode active material layer 7 of the lithium ion secondary battery 10 of this embodiment includes the vanadium lithium phosphate 9. As the vanadium lithium phosphate 9, at least one of LiVOPO₄, Li₃V₂(PO₄)₃, Li₂VOP₂O₇, Li₂VP₂O₇, Li₄(VO)(PO₄)₂, and Li₉V₃(P₂O₇)₃(PO₄)₂ can be used. In particular, at least one of LiVOPO₄ and Li₃V₂(PO₄)₃ can be used. Alternatively, lithium-deficient LiVOPO₄ and Li₃V₂(PO₄)₃ can be used. In particular, LiₓVOPO₄ (0.94≦x≦0.98) and LiₓV₂(PO₄)₃ (2.8≦x≦2.95) can be used.

The materials of the positive electrode active material layer 5 and the negative electrode active material layer 7 may be exactly the same. In regard to the above non-polar lithium ion secondary battery 10, it is not necessary to designate the orientation when the battery 10 is attached to the circuit board. This leads to the advantage that the mounting speed is improved drastically.

The particle diameter of the vanadium lithium phosphate 9 may be in the range of 0.4 μm to 4 μm.

The surface of the vanadium lithium phosphate 9 may be coated with at least one constituent of titanium and aluminum. On this occasion, the thickness of the coating layer that coats the vanadium lithium phosphate 9 particle may be in the range of 0.1 μm to 1 μm.

Moreover, the at least one constituent may exist even inside of the particle of the active material and moreover may be distributed with the concentration gradient from the surface of the particle to the inside of the particle.

The positive electrode active material layer 5 and the negative electrode active material layer 7 may include other positive electrode active material and negative electrode active material than the vanadium lithium phosphate 9. For example, a transition metal oxide or a transition metal composite oxide may be contained. Specifically, at least one of lithium manganese composite oxide Li₂Mnₓ₃Ma₁₋ₓ₃O₃ (0.8≦x3≦1, Ma=Co, Ni), lithium cobaltate (LiCoO₂), lithium nickelate (LiNiO₂), lithium manganese spinel (LiMn₂O₄), composite metal oxides represented by general formula: LiNiₓ₄CooMn_{z4}O₂ (x4+y4+z4=1, 0≦x4≦1, 0≦y4≦1, 0≦z4≦1), a lithium vanadium compound (LiV₂O₅), olivine LiMbPO₄ (wherein Mb represents one or more elements selected from Co, Ni, Mn, Fe, Mg, Nb, Ti, Al, and Zr), Li-excess solid solution positive electrode Li₂MnO₃—LiMcO₂ (Mc=Mn, Co, Ni), lithium titanate (Li₄Ti₅O₁₂), and composite metal oxides represented by LiₐNiₓ₅Co_{y5}Al_{z5}O₂ (0.9<a<1.3, 0.9<x5+y5+z5<1.1) may be used. The content of these materials may in the range of 1 parts by mass to 20 parts by mass relative to 100 parts by mass of the vanadium lithium phosphate 9 in the same active material layer.

Here, the active materials included in the positive electrode active material layer 5 and the negative electrode active material layer 7 are not clearly distinguished. Out of the two kinds of compounds included in the positive electrode active material layer 5 and the negative electrode active material layer 7, the potentials of the compounds are compared and the compound with nobler potential is used as the positive electrode active material and the compound with baser potential is used as the negative electrode active material. The same compound may be used for the positive electrode active material layer 5 and the negative electrode active material layer 7 as long as the compound is capable of intercalation and deintercalation of lithium ions.

### (Positive Electrode Current Collector and Negative Electrode Current Collector)

As the material of the positive electrode current collector layer 4 and the negative electrode current collector layer 6 of the lithium ion secondary battery 10 of this embodiment, the material with high electric conductivity can be used. For example, silver, palladium, gold, platinum, aluminum, copper, or nickel can be used. In particular, copper uneasily reacts with the titanium aluminum lithium phosphate 8 and therefore is effective in reducing the internal resistance of the lithium ion secondary battery 10. The material of the positive electrode current collector layer 4 may be either the same or different from the material of the negative electrode current collector layer 6.

The positive electrode current collector layer 4 and the negative electrode current collector layer 6 of the lithium ion secondary battery 10 of this embodiment may include the positive electrode active material and the negative electrode active material, respectively.

When the positive electrode current collector layer 4 and the negative electrode current collector layer 6 include the positive electrode active material and the negative electrode active material, respectively, the adhesion between the positive electrode current collector layer 4 and the positive electrode active material layer 5 and the adhesion between the negative electrode current collector layer 6 and the negative electrode active material layer 7 are improved.

In this embodiment, the ratio of the positive electrode active material layer and the negative electrode active material layer included in the positive electrode current collector layer 4 and the negative electrode current collector layer 6 is not particularly limited as long as the function as the current collector is not deteriorated. The volume ratio of the positive electrode active material included in the positive electrode current collector layer 4 to the positive electrode current collector included in the layer 4 and the volume ratio of the negative electrode active material included in the negative electrode current collector layer 6 to the negative electrode current collector included in the layer 6 may be in the range of 90/10 to 70/30.

### (Manufacturing Method for Lithium Ion Secondary Battery)

For manufacturing the lithium ion secondary battery 10 according to this embodiment, first, each material of the positive electrode current collector layer 4, the positive electrode active material layer 5, the solid electrolyte layer 3, the negative electrode active material layer 7, and the negative electrode current collector layer 6, which has been made into a paste, is prepared. Next, these materials are coated and dried, whereby green sheets are manufactured. The obtained green sheets are stacked to manufacture a stacked body, and by firing the stacked body at the same time, the lithium ion secondary battery 10 is manufactured.

A method of making the material into a paste is not limited in particular. For example, the paste can be obtained by mixing the powder of each material in vehicle. Here, the vehicle is a collective term for the medium in a liquid phase. The vehicle includes the solvent and the binder. By this method, the pastes for the positive electrode current collector layer 4, the positive electrode active material layer 5, the solid electrolyte layer 3, the negative electrode active material layer 7, and the negative electrode current collector layer 6 are prepared.

The prepared paste is coated on a base material such as PET (polyethylene terephthalate) in the desired order. Next, the paste on the base material is dried as necessary and then the base material is removed; thus, the green sheet is manufactured. The method of coating the paste is not particularly limited. Any of known methods including the screen printing, the coating, the transcription, and the doctor blade can be used.

A desired number of green sheets can be stacked in the desired order. If necessary, alignment, cutting and the like can be performed to manufacture a stacking block. In the case of manufacturing a parallel type or serial-parallel type battery, the alignment may be conducted when the green sheets are stacked, so that the end face of the positive electrode layer 1 does not coincide with the end face of the negative electrode layer 2.

In order to manufacture the stacked body, the active material unit to be described below may be prepared and the stacking block may be manufactured.

First, the paste for the solid electrolyte layer 3 is formed into a sheet shape on a PET film by the doctor blade method. After the paste for the positive electrode active material layer 5 is printed on the obtained sheet for the solid electrolyte layer 3 by the screen printing, the printed paste is dried. Next, the paste for the positive electrode current collector layer 4 is printed thereon by the screen printing, and then the printed paste is dried. Furthermore, the paste for the positive electrode active material layer 5 is printed again thereon by the screen printing, and the printed paste is dried. Next, by removing the PET film, the positive electrode active material layer unit is obtained. In this manner, the positive electrode active material layer unit in which the paste for the positive electrode active material layer 5, the paste for the positive electrode current collector layer 4, and the paste for the positive electrode active material layer 5 are formed in this order on the sheet for the solid electrolyte layer 3 is obtained. In the similar procedure, the negative electrode active material layer unit is also manufactured. The negative electrode active material layer unit in which the paste for the negative electrode active material layer 7, the paste for the negative electrode current collector layer 6, and the paste for the negative electrode active material layer 7 are formed in this order on the sheet for the solid electrolyte layer 3 is obtained.

One positive electrode active material layer unit and one negative electrode active material layer unit are stacked so that the paste for the positive electrode active material layer 5, the paste for the positive electrode current collector layer 4, the paste for the positive electrode active material layer 5, the sheet for the solid electrolyte layer 3, the paste for the negative electrode active material layer 7, the paste for the negative electrode current collector layer 6, the paste for the negative electrode active material layer 7, and the sheet for the solid electrolyte layer 3 are disposed in this order. On this occasion, the units may be displaced so that the paste for the positive electrode current collector layer 4 of the first positive electrode active material layer unit extends to one end face only and the paste for the negative electrode current collector layer 6 of the second negative electrode active material layer unit extends to the other end face only. On both surfaces of the thusly stacked units, the sheet for the solid electrolyte layer 3 with predetermined thickness is stacked, thereby forming the stacking block.

The manufactured stacking block is crimped at the same time. The crimping is performed while heat is applied. The heating temperature is, for example, 40° C. to 95° C.

The crimped stacking block is fired by being heated at 600° C. to 1000° C. under the nitrogen atmosphere. The firing time is, for example, 0.1 to 3 hours. Through this firing, the stacked body is completed.

### EXAMPLES

### Example 1-1

An embodiment of the present disclosure is hereinafter described with reference to examples. The embodiment of the present disclosure is, however, not limited to these examples. Note that “parts” refer to “parts by mass” unless otherwise stated.

### (Preparation of Positive Electrode Active Material and Negative Electrode Active Material)

As the positive electrode active material and the negative electrode active material, Li₃V₂(PO₄)₃ prepared by the method below was used. First, Li₂CO₃, V₂O₅, and NH₄H₂PO₄ as the starting material were wet mixed for 16 hours using a ball mill. The powder obtained after dehydration and drying was calcined for two hours at 850° C. in a nitrogen-hydrogen mix gas. The calcined product was wet pulverized and then dehydrated and dried, whereby the positive electrode active material powder and the negative electrode active material powder were obtained. It has been confirmed that the prepared powder had a constituent of Li₃V₂(PO₄)₃ according to the X-ray diffraction apparatus.

### (Preparation of Paste for Positive Electrode Active Material Layer and Paste for Negative Electrode Active Material Layer)

The paste for the positive electrode active material layer and the paste for the negative electrode active material layer were prepared as below. In other words, 15 parts of ethyl cellulose as the binder and 65 parts of dihydroterpineol as the solvent were added to 100 parts of powder of Li₃V₂(PO₄)₃ to be mixed. Thus, the powder is dispersed in the solvent, whereby the paste for the positive electrode active material layer and the paste for the negative electrode active material layer were obtained.

### (Preparation of Paste for Solid Electrolyte Layer)

As the solid electrolyte, Li_{1.3}Al_{0.3}Ti₁₇(PO₄)₃ prepared by the method below was used. First, Li₂CO₃, Al₂O₃, TiO₂, and NH₄H₂PO₄ as the starting material were wet mixed for 16 hours using a ball mill. The powder obtained after dehydration and drying was calcined in the air for two hours at 800° C. The calcined product was wet pulverized for 16 hours using a ball mill and then dehydrated and dried, whereby the powder of the solid electrolyte was obtained. It has been confirmed that the prepared powder has a constituent of Li₁₃Al_{0.3}Ti_{1.7}(PO₄)₃ using the X-ray diffraction apparatus.

Next, this powder was wet mixed with 100 parts of ethanol and 200 parts of toluene as the solvent in the ball mill. After that, 16 parts of polyvinylbutyral binder and 4.8 parts of benzylbutylphthalate were further charged therein and mixed, whereby the paste for the solid electrolyte layer was prepared.

### (Manufacture of Sheet for Solid Electrolyte Layer)

By molding a sheet with the paste for the solid electrolyte layer on a PET film as the base material by a doctor blade method, a sheet for a solid electrolyte layer with a thickness of 15 μm was obtained.

### (Preparation of Paste for Positive Electrode Current Collector Layer and Paste for Negative Electrode Current Collector Layer)

The powder of Cu and Li₃V₂(PO₄)₃ used as the positive electrode current collector and the negative electrode current collector was mixed at a volume ratio of 80/20. After that, 10 parts of ethyl cellulose as the binder and 50 parts of dihydroterpineol as the solvent were added and mixed, whereby the powder was dispersed in the solvent and thus the paste for the positive electrode current collector layer and the paste for the negative electrode current collector layer were obtained. The average particle diameter of Cu was 0.9 μm.

### (Preparation of Terminal Electrode Paste)

By mixing silver powder, epoxy resin, and solvent, the powder was dispersed in the solvent and a thermosetting terminal electrode paste was obtained.

With the use of these pastes, the lithium ion secondary battery was manufactured as below.

### (Manufacture of Positive Electrode Active Material Layer Unit)

The paste for the positive electrode active material layer with a thickness of 5 μm was printed on the sheet for the above described solid electrolyte layer by the screen printing. The printed paste was dried for 10 minutes at 80° C. Next, the paste for the positive electrode current collector layer with a thickness of 5 μm was printed thereon by the screen printing. The printed paste was dried for 10 minutes at 80° C. The paste for the positive electrode active material layer with a thickness of 5 μm was printed again thereon by the screen printing. The printed paste was dried for 10 minutes at 80° C. Next, the PET film was removed. Thus, the sheet of the positive electrode active material layer unit was obtained in which the paste for the positive electrode active material layer, the paste for the positive electrode current collector layer, and the paste for the positive electrode active material layer were printed and dried in this order on the sheet for the solid electrolyte layer.

### (Manufacture of Negative Electrode Active Material Layer Unit)

The paste for the negative electrode active material layer with a thickness of 5 μm was printed on the sheet for the above described solid electrolyte layer by the screen printing. The printed paste was dried for 10 minutes at 80° C. Next, the paste for the negative electrode current collector layer with a thickness of 5 μm was printed thereon by the screen printing. The printed paste was dried for 10 minutes at 80° C. The paste for the negative electrode active material layer with a thickness of 5 μm was printed again thereon by the screen printing. The printed paste was dried for 10 minutes at 80° C.

Next, the PET film was removed. Thus, the sheet of the negative electrode active material layer unit was obtained in which the paste for the negative electrode active material layer, the paste for the negative electrode current collector layer, and the paste for the negative electrode active material layer were printed and dried in this order on the sheet for the solid electrolyte layer.

### (Manufacture of Stacked Body)

The positive electrode active material layer unit and the negative electrode active material layer unit were stacked so that the paste for the positive electrode active material layer, the paste for the positive electrode current collector layer, the paste for the positive electrode active material layer, the sheet for the solid electrolyte layer, the paste for the negative electrode active material layer, the paste for the negative electrode current collector layer, the paste for the negative electrode active material layer, and the sheet for the solid electrolyte layer were disposed in this order. On this occasion, the units were displaced so that the paste for the positive electrode current collector layer of the positive electrode active material layer unit extends to one end face only and the paste for the negative electrode current collector layer of the negative electrode active material layer unit extends to the other end face only. The sheet for the solid electrolyte layer was stacked on both surfaces of the stacked units so that the thickness became 500 μm. After that, this was molded by the thermal crimping method, and cut, thereby forming a stacking block. After that, the stacking block was fired at the same time to provide a stacked body. The firing was conducted in nitrogen in a manner that the temperature was increased up to a firing temperature of 750° C. at a temperature rising rate of 200° C./hour and then the temperature was maintained for two hours. The stacked body after firing was cooled naturally.

### (Step of Forming Terminal Electrode)

The terminal electrode paste was coated to the end face of the stacking block. The paste on the end face was thermally cured at 150° C. for 30 minutes, thereby forming a pair of terminal electrodes. Thus, the lithium ion secondary battery was completed.

### Example 1-2

A lithium ion secondary battery was manufactured by the same method as that in Example 1-1 except that the firing temperature was set to 800° C. in firing the stacking block at the same time.

### Comparative Example 1-1

A lithium ion secondary battery was manufactured by the same method as that in Example 1-1 except that the firing temperature was set to 700° C. in firing the stacking block at the same time.

### Example 2-1

LiVOPO₄ prepared by the method below was used as the positive electrode active material and the negative electrode active material. First, Li₂CO₃, V₂O₅, and NH₄H₂PO₄ as the starting material were wet mixed for 16 hours using a ball mill. The powder obtained after dehydration and drying was calcined in a nitrogen-hydrogen mix gas for two hours at 650° C. The calcined product was wet pulverized for 16 hours using the ball mill and then dehydrated and dried, whereby the positive electrode active material powder and the negative electrode active material powder were obtained. It has been confirmed that the prepared powder has the constituent of LiVOPO₄ using the X-ray diffraction apparatus.

A lithium ion secondary battery was manufactured by the same method as that in Example 1-1 except that LiVOPO₄ was used as the positive electrode active material and the negative electrode active material.

### Example 2-2

A lithium ion secondary battery was manufactured by the same method as that in Example 2-1 except that the firing temperature was set to 800° C. in firing the stacking block at the same time.

### Comparative Example 2-1

A lithium ion secondary battery was manufactured by the same method as that in Example 2-1 except that the firing temperature was set to 700° C. in firing the stacking block at the same time.

### Example 3-1

A lithium ion secondary battery was manufactured by the same method as that in Example 1-1 except that LiVOPO₄ was used as the paste for the negative electrode active material layer.

### Example 3-2

A lithium ion secondary battery was manufactured by the same method as that in Example 3-1 except that the firing temperature was set to 800° C. in firing the stacking block at the same time.

### Comparative Example 3-1

A lithium ion secondary battery was manufactured by the same method as that in Example 3-1 except that the firing temperature was set to 700° C. in firing the stacking block at the same time.

### Comparative Example 4-1

A lithium ion secondary battery was manufactured by the same method as that in Comparative Example 3-1 except that LiFePO₄ was used as the paste for the positive electrode active material layer and Li₄Ti₅O₁₂ was used as the paste for the negative electrode active material layer.

### Comparative Example 4-2

A lithium ion secondary battery was manufactured by the same method as that in Comparative Example 4-1 except that the firing temperature was set to 750° C. in firing the stacking block at the same time.

### Comparative Example 4-3

A lithium ion secondary battery was manufactured by the same method as that in Comparative Example 4-1 except that the firing temperature was set to 800° C. in firing the stacking block at the same time.

### Example 5-1

A lithium ion secondary battery was manufactured by the same method as that in Example 1-2 except that Li_{2.95}V₂(PO₄)₃ was used as the positive electrode active material and the negative electrode active material.

### Example 5-2

A lithium ion secondary battery was manufactured by the same method as in Example 1-2 except that Li_{2.9}V₂(PO₄)₃ was used as that the positive electrode active material and the negative electrode active material.

### Example 5-3

A lithium ion secondary battery was manufactured by the same method as that in Example 1-2 except that Li_{2.8}V₂(PO₄)₃ was used as the positive electrode active material and the negative electrode active material.

### Example 5-4

A lithium ion secondary battery was manufactured by the same method as that in Example 1-2 except that Li_{2.7}V₂(PO₄)₃ was used as the positive electrode active material and the negative electrode active material.

### Example 5-5

A lithium ion secondary battery was manufactured by the same method as that in Example 1-2 except that Li_{2.6}V₂(PO₄)₃ was used as the positive electrode active material and the negative electrode active material.

### Example 6-1

A lithium ion secondary battery was manufactured by the same method as that in Example 1-2 except that Li_{0.98}VOPO₄ was used as the positive electrode active material and the negative electrode active material.

### Example 6-2

A lithium ion secondary battery was manufactured by the same method as that in Example 1-2 except that Li_{0.96}VOPO₄ was used as the positive electrode active material and the negative electrode active material.

### Example 6-3

A lithium ion secondary battery was manufactured by the same method as that in Example 1-2 except that Li_{0.94}VOPO₄ was used as the positive electrode active material and the negative electrode active material.

### Example 6-4

A lithium ion secondary battery was manufactured by the same method as that in Example 1-2 except that Li_{0.92}VOPO₄ was used as the positive electrode active material and the negative electrode active material.

### Example 6-5

A lithium ion secondary battery was manufactured by the same method as that in Example 1-2 except that Li_{0.90}VOPO₄ was used as the positive electrode active material and the negative electrode active material.

### (Evaluation of Batteries)

The lithium ion secondary batteries each having a lead wire connected to the terminal electrode were subjected to the repeated charging/discharging tests under the measurement conditions below. In other words, the current at the charging and discharging was 2.0 The cutoff voltage at the charging and discharging was 4.0 V and 0 V, respectively. The internal resistance calculated from the discharge capacity in the fifth cycle and the voltage drop at the start of the discharging is shown as the internal resistance before the acceleration test in Table 1. For evaluating the reliability, the acceleration test was carried out under the condition of a temperature of 60° C., a humidity of 90%, and 200 hours. The internal resistance measured after the test is also shown in Table 1 as the internal resistance after the acceleration test.

### (Observation of Section of Battery)

Table 1 also shows whether at least one constituent of titanium and aluminum in the active material layer exists in the section of the lithium ion secondary battery of Example 1-2 according to the EPMA-WDS element mapping. Here, the sample for observing the section of the lithium ion secondary battery was manufactured by embedding the lithium ion secondary battery in resin and mechanically polishing the section.

TABLE 1

| | | | | | | | Internal | Internal |
|---|---|---|---|---|---|---|---|---|
| | | | | | | Discharge | resistance | resistance |
| | Positive | Negative | | Al in | Ti in | capacity | before | after |
| | electrode | electrode | Firing | vanadium | vanadium | before | acceleration | acceleration |
| | active | active | temperature | lithium | lithium | acceleration | test | test |
| | material | material | [° C.] | phosphate | phosphate | test [μA] | [kΩ] | [kΩ] |
| Example 1-1 | Li₃V₂(PO₄)₃ | Li₃V₂(PO₄)₃ | 750 | Present | Absent | 4.2 | 55 | 57 |
| Example 1-2 | Li₃V₂(PO₄)₃ | Li₃V₂(PO₄)₃ | 800 | Present | Present | 4.8 | 40 | 41 |
| Comparative | Li₃V₂(PO₄)₃ | Li₃V₂(PO₄)₃ | 700 | Absent | Absent | 0.4 | 650 | 2100 |
| Example 1-1 | | | | | | | | |
| Example 2-1 | LiVOPO₄ | LiVOPO₄ | 750 | Present | Absent | 3.7 | 66 | 73 |
| Example 2-2 | LiVOPO₄ | LiVOPO₄ | 800 | Present | Present | 4.1 | 56 | 61 |
| Comparative | LiVOPO₄ | LiVOPO₄ | 700 | Absent | Absent | 0.3 | 780 | 2840 |
| Example 2-1 | | | | | | | | |
| Example 3-1 | Li₃V₂(PO₄)₃ | LiVOPO₄ | 750 | Present | Present | 4.0 | 58 | 60 |
| Example 3-2 | Li₃V₂(PO₄)₃ | LiVOPO₄ | 800 | Present | Present | 4.4 | 46 | 49 |
| Comparative | Li₃V₂(PO₄)₃ | LiVOPO₄ | 700 | Absent | Absent | 0.4 | 690 | 2420 |
| Example 3-1 | | | | | | | | |
| Comparative | LiFePO₄ | Li₄Ti₅O₁₂ | 700 | Absent | Absent | 0.1 | 1430 | 4120 |
| Example 4-1 | | | | | | | | |
| Comparative | LiFePO₄ | Li₄Ti₅O₁₂ | 750 | Absent | Absent | 0.3 | 880 | 3650 |
| Example 4-2 | | | | | | | | |
| Comparative | LiFePO₄ | Li₄Ti₅O₁₂ | 800 | Absent | Absent | 0.3 | 890 | 3770 |
| Example 4-3 | | | | | | | | |
| Example 5-1 | Li_{2.95}V₂(PO₄)₃ | Li_{2.95}V₂(PO₄)₃ | 800 | Present | Present | 7.6 | 31 | 31 |
| Example 5-2 | Li_{2.9}V₂(PO₄)₃ | Li_{2.9}V₂(PO₄)₃ | 800 | Present | Present | 7.5 | 31 | 32 |
| Example 5-3 | Li_{2.8}V₂(PO₄)₃ | Li_{2.8}V₂(PO₄)₃ | 800 | Present | Present | 7.2 | 32 | 32 |
| Example 5-4 | Li_{2.7}V₂(PO₄)₃ | Li_{2.7}V₂(PO₄)₃ | 800 | Present | Present | 5.1 | 41 | 42 |
| Example 5-5 | Li_{2.6}V₂(PO₄)₃ | Li_{2.6}V₂(PO₄)₃ | 800 | Present | Present | 5.1 | 40 | 41 |
| Example 6-1 | Li_{0.98}VOPO₄ | Li_{0.98}VOPO₄ | 800 | Present | Present | 6.2 | 26 | 26 |
| Example 6-2 | Li_{0.96}VOPO₄ | Li_{0.96}VOPO₄ | 800 | Present | Present | 6.0 | 28 | 29 |
| Example 6-3 | Li_{0.94}VOPO₄ | Li_{0.94}VOPO₄ | 800 | Present | Present | 5.8 | 29 | 31 |
| Example 6-4 | Li_{0.92}VOPO₄ | Li_{0.92}VOPO₄ | 800 | Present | Present | 4.5 | 49 | 50 |
| Example 6-5 | Li_{0.90}VOPO₄ | Li_{0.90}VOPO₄ | 800 | Present | Present | 4.4 | 50 | 50 |

According to Table 1, the internal resistance has largely decreased and the discharge capacity has increased in Examples 1-1, 1-2, 2-1, 2-2, 3-1 and 3-2 where at least one constituent of titanium and aluminum is diffused in vanadium lithium phosphate as compared to Comparative Examples 1-1, 2-1, and 3-1 where neither aluminum nor titanium is diffused.

In regard to the change in internal resistance before and after the acceleration test, the internal resistance has increased just a little but not substantially changed in Examples 1-1, 1-2, 2-1, 2-2, 3-1, and 3-2 where at least one constituent of titanium and aluminum is diffused in vanadium lithium phosphate. In contrast to this, the internal resistance has increased largely in Comparative Examples 1-1, 2-1, and 3-1 were neither titanium nor aluminum is diffused.

On the other hand, neither titanium nor aluminum has been confirmed in the positive electrode active material layer containing LiFePO₄ as the positive electrode active material after firing. In particular, even though the firing temperature was changed in Comparative Examples 4-1, 4-2, and 4-3, the discharge capacity did not increase and the internal resistance did not decrease largely. The internal resistance after the acceleration test was much higher than that before the acceleration test.

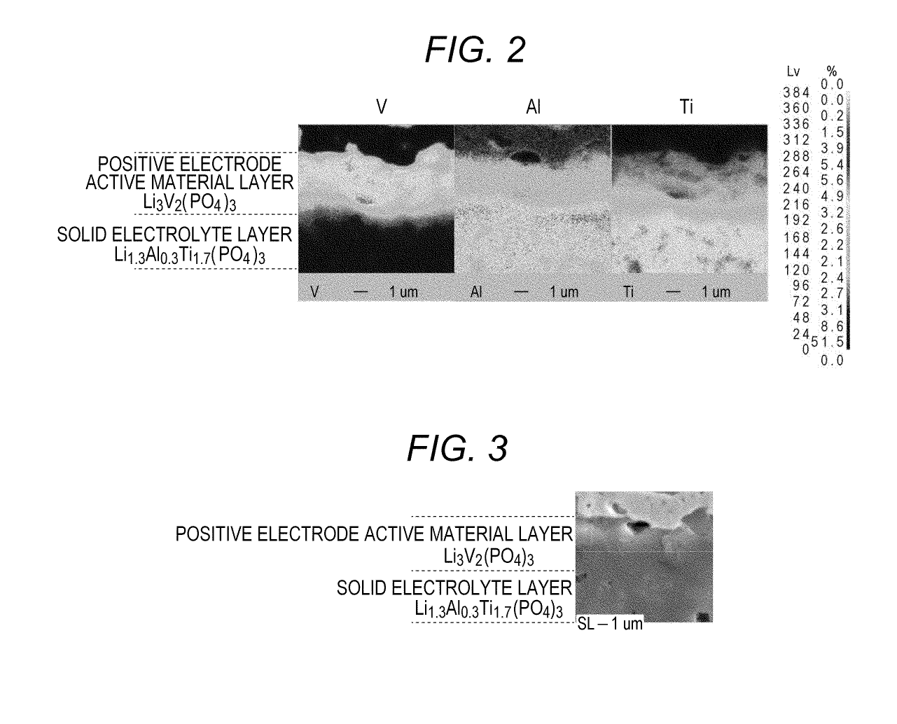

FIG. 2 shows the EPMA-WDS element mapping of the interface portion between the positive electrode active material layer and the solid electrolyte layer after firing included in the lithium ion secondary battery used in Example 1-2. Moreover, FIG. 3 shows the secondary electron image of the above described interface portion. As shown in FIG. 2, neither titanium nor aluminum included in Li_{1.3}Al_{0.3}Ti_{1.7}(PO₄)₃ of the solid electrolyte layer was present in the positive electrode active material layer before sintering. However, after firing, titanium and aluminum were distributed with concentration gradient across the entire layer of Li₃V₂(PO₄)₃ included in the positive electrode active material layer with a thickness of approximately 2.5 μm. In other words, the amount of titanium and aluminum existing on the solid electrolyte layer side in the Li₃V₂(PO₄)₃ layer was smaller than the amount of titanium and aluminum existing on the opposite side (positive electrode current collector layer side). From the viewpoint of each particle, it is confirmed that titanium and aluminum are distributed with the concentration gradient from the surface of the particle of Li₃V₂(PO₄)₃ to the inside of the particle.

The titanium and aluminum distribution at the interface portion between the negative electrode active material layer and the solid electrolyte layer was similar to the distribution at the interface portion between the positive electrode active material layer and the solid electrolyte layer. In other words, the distribution had the concentration gradient so that titanium and aluminum exist less on the negative electrode current collector layer side than on the solid electrolyte side. From the viewpoint of each particle, it is found that titanium and aluminum are distributed with the concentration gradient from the surface of the particle of Li₃V₂(PO₄)₃ to the inside of the particle.

Moreover, the diffusion ratio of aluminum and titanium into Li₃V₂(PO₄)₃ included in the positive electrode active material layer was measured. As a result, when the diffusion ratio of aluminum to titanium (aluminum element concentration/titanium element concentration) in the solid electrolyte layer is 1, the diffusion ratio is 1.28 in the positive electrode active material layer near the interface with the solid electrolyte layer, 1.38 in the center in the thickness direction of the positive electrode active material layer, and 1.83 in the positive electrode active material layer near the interface with the positive electrode current collector. In other words, it has been clarified that aluminum is diffused in a wider range than titanium. This may be because the ion diameter of Al³⁺ (50 μm) is smaller than the ion diameter of Ti⁴⁺ (68 μm) and therefore aluminum can diffuse farther. Moreover, it is supposed that aluminum plays the role of forming the firm bond and additionally forming a path of conducting ions, thereby reducing the internal resistance.

On the other hand, vanadium included in Li₃V₂(PO₄)₃ of the positive electrode active material layer was not distributed in Li_{1.3}Al_{0.3}Ti_{1.7}(PO₄)₃ of the solid electrolyte layer.

The observation of the secondary electron image of FIG. 3 indicates that the positive electrode active material layer including Li₃V₂(PO₄)₃ and the solid electrolyte layer including Li_{1.3}Al_{0.3}Ti_{1.7}(PO₄)₃ are firmly bonded to each other. Although not shown, however, in Comparative Examples 1-1, 2-1, and 3-1, the portion where the positive electrode active material layer and the solid electrolyte layer were bonded or the portion where the negative electrode active material layer and the solid electrolyte layer were bonded was partly removed.

The above results indicate that at least one constituent of aluminum and titanium of Li_{1.3}Al_{0.3}Ti_{1.7}(PO₄)₃ of the solid electrolyte layer is diffused in the active material layer with the concentration gradient so that the constituent exists less on the side opposite to the solid electrolyte layer side (current collector layer side) in Li₃V₂(PO₄)₃ than on the solid electrolyte layer side. This diffusion enables titanium and aluminum to be disposed finally at the optimum positions. In other words, titanium and aluminum can have the optimum distribution state. It is considered that this results in the firm bonding between the active material layer and the solid electrolyte layer. In addition, the contact area at the interface between the active material layer and the solid electrolyte layer is increased at the same time, whereby the internal resistance of the lithium ion secondary battery is reduced.

Moreover, short-circuiting did not occur in any of Examples 1-1, 1-2, 2-1, 2-2, 3-1, and 3-2. It is considered that this is because vanadium in Li₃V₂(PO₄)₃ did not diffuse to Li_{1.3}Al_{0.3}Ti_{1.7}(PO₄)₃, so that the short-circuiting of the lithium ion secondary battery was suppressed.

Next, the results of Examples 1-1, 5-1, 5-2, 5-3, 5-4, and 5-5 in Table 1 were compared. Here, the positive electrode active material and the negative electrode active material were Li₃V₂(PO₄)₃ with no lithium deficiency in Example 1-1 and Li₃V₂(PO₄)₃ with lithium deficiency in the other examples. As a result, Examples 5-1, 5-2, 5-3, 5-4, and 5-5 employing Li₃V₂(PO₄)₃ with lithium deficiency exhibited lower internal resistance before the acceleration test and higher discharge capacity. Moreover, the increase in internal resistance after the acceleration test relative to the internal resistance before the acceleration test was small.

Similarly, the results of Examples 1-1, 6-1, 6-2, 6-3, 6-4, and 6-5 in Table 1 were compared. Here, the positive electrode active material and the negative electrode active material were LiVOPO₄ with no lithium deficiency in Example 1-1 and LiVOPO₄ with lithium deficiency in the other examples. As a result, Examples 6-1, 6-2, 6-3, 6-4, and 6-5 employing LiVOPO₄ with lithium deficiency exhibited lower internal resistance before the acceleration test and higher discharge capacity. Moreover, the increase in internal resistance after the acceleration test relative to the internal resistance before the acceleration test was small.

Based on the results, it is considered that the lithium deficiency in the positive electrode active material and the negative electrode active material promotes the diffusion of titanium and aluminum in the firing. As a result, helping titanium and aluminum to be disposed at the optimum positions has enabled the lithium ion secondary battery to have lower internal resistance and higher discharge capacity. The lithium ion secondary battery according to the embodiment of the present disclosure may be any of the following first to sixth lithium ion secondary batteries.

A first lithium ion secondary battery is a lithium ion secondary battery including a solid electrolyte layer between a pair of electrodes. The solid electrolyte layer includes titanium aluminum lithium phosphate. At least one of the pair of electrodes includes vanadium lithium phosphate. At least one of the pair of electrodes includes one constituent or both constituents of titanium and aluminum. The constituent exists less on a side opposite to the solid electrolyte layer than on the solid electrolyte layer side.

A second lithium ion secondary battery is a lithium ion secondary battery including a solid electrolyte layer between a positive electrode layer and a negative electrode layer. The positive electrode layer includes a positive electrode current collector layer and a positive electrode active material layer. The negative electrode layer includes a negative electrode current collector layer and a negative electrode active material layer. The solid electrolyte layer provided between the positive electrode active material layer and the negative electrode active material layer includes titanium aluminum lithium phosphate. Either or both of the positive electrode active material layer and the negative electrode active material layer include vanadium lithium phosphate and include either or both of titanium and aluminum. Titanium or aluminum included in the positive electrode active material layer or the negative electrode active material layer exists less on the current collector layer side than on the solid electrolyte layer side.

In a third lithium ion secondary battery according to the first or second lithium ion secondary battery, the titanium aluminum lithium phosphate is Li₁₊ₓAlₓTi₂₋ₓ(PO₄)₃ (0≦x≦0.6).

In a fourth lithium ion secondary battery according to any of the first to third lithium ion secondary batteries, the vanadium lithium phosphate is either or both of LiVOPO₄ and Li₃V₂(PO₄)₃.

In a fifth lithium ion secondary battery according to any of the first to fourth lithium ion secondary batteries, the positive electrode current collector layer and the negative electrode current collector layer include Cu.

A sixth lithium ion secondary battery is a lithium ion secondary battery including a solid electrolyte layer between a positive electrode layer and a negative electrode layer. The positive electrode layer includes a positive electrode current collector layer and a positive electrode active material layer. The negative electrode layer includes a negative electrode current collector layer and a negative electrode active material layer. The solid electrolyte layer provided between the positive electrode active material layer and the negative electrode active material layer includes titanium aluminum lithium phosphate. Either or both of the positive electrode active material layer and the negative electrode active material layer include vanadium lithium phosphate. Either or both of titanium and aluminum is diffused in the vanadium lithium phosphate.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A lithium ion secondary battery comprising a pair of electrodes and a solid electrolyte layer, wherein:
the solid electrolyte layer is provided between the pair of electrodes and includes titanium aluminum lithium phosphate;
at least one of the pair of electrodes includes vanadium lithium phosphate;
at least one of the pair of electrodes includes at least one constituent of titanium and aluminum; and
an amount of the at least one constituent existing on a side opposite to the solid electrolyte layer side is smaller than an amount of the at least one constituent existing on the solid electrolyte layer side in the at least one electrode.

2. A lithium ion secondary battery comprising a positive electrode layer, a negative electrode layer, and a solid electrolyte layer, wherein:
the positive electrode layer includes a positive electrode current collector layer and a positive electrode active material layer;
the negative electrode layer includes a negative electrode current collector layer and a negative electrode active material layer;
the solid electrolyte layer is provided between the positive electrode active material layer and the negative electrode active material layer, and includes titanium aluminum lithium phosphate;
at least one layer of the positive electrode active material layer and the negative electrode active material layer includes vanadium lithium phosphate and includes at least one constituent of titanium and aluminum; and
an amount of the at least one constituent existing on the current collector layer side is smaller than an amount of the at least one constituent existing on the solid electrolyte layer side in the at least one layer.

3. The lithium ion secondary battery according to claim 1, wherein the titanium aluminum lithium phosphate is Li₁₊ₓAlₓTi₂₋ₓ(PO₄)₃ (0≦x≦0.6).

4. The lithium ion secondary battery according to claim 2, wherein the titanium aluminum lithium phosphate is Li₁₊ₓAlₓTi₂₋ₓ(PO₄)₃ (0≦x≦0.6).

5. The lithium ion secondary battery according to claim 1, wherein the vanadium lithium phosphate is at least one of LiVOPO₄ and Li₃V₂(PO₄)₃.

6. The lithium ion secondary battery according to claim 2, wherein the vanadium lithium phosphate is at least one of LiVOPO₄ and Li₃V₂(PO₄)₃.

7. The lithium ion secondary battery according to claim 3, wherein the vanadium lithium phosphate is at least one of LiVOPO₄ and Li₃V₂(PO₄)₃.

8. The lithium ion secondary battery according to claim 4, wherein the vanadium lithium phosphate is at least one of LiVOPO₄ and Li₃V₂(PO₄)₃.

9. The lithium ion secondary battery according to claim 1, wherein the positive electrode current collector layer and the negative electrode current collector layer include Cu.

10. The lithium ion secondary battery according to claim 2, wherein the positive electrode current collector layer and the negative electrode current collector layer include Cu.

11. The lithium ion secondary battery according to claim 3, wherein the positive electrode current collector layer and the negative electrode current collector layer include Cu.

12. The lithium ion secondary battery according to claim 4, wherein the positive electrode current collector layer and the negative electrode current collector layer include Cu.

13. The lithium ion secondary battery according to claim 5, wherein the positive electrode current collector layer and the negative electrode current collector layer include Cu.

14. The lithium ion secondary battery according to claim 6, wherein the positive electrode current collector layer and the negative electrode current collector layer include Cu.

15. The lithium ion secondary battery according to claim 7, wherein the positive electrode current collector layer and the negative electrode current collector layer include Cu.

16. The lithium ion secondary battery according to claim 8, wherein the positive electrode current collector layer and the negative electrode current collector layer include Cu.

17. A lithium ion secondary battery comprising a positive electrode layer, a negative electrode layer, and a solid electrolyte layer, wherein:
the positive electrode layer includes a positive electrode current collector layer and a positive electrode active material layer;
the negative electrode layer includes a negative electrode current collector layer and a negative electrode active material layer;
the solid electrolyte layer is provided between the positive electrode active material layer and the negative electrode active material layer, and includes titanium aluminum lithium phosphate;
at least one layer of the positive electrode active material layer and the negative electrode active material layer includes vanadium lithium phosphate and includes at least one constituent of titanium and aluminum; and
the at least one constituent of titanium and aluminum is diffused in the vanadium lithium phosphate.
